(19) United States
(12) Patent Application Publication
(10) Pub. No.: US 2018/0162759 A1
(43) Pub. Date: Jun. 14, 2018

(54) METHODS, COMPOSITIONS AND SYSTEMS FOR REDUCING POLLUTANTS IN GARBAGE LEACHATE

(71) Applicant: Saeid Reza Kashtiara, Tehran (IR)

(72) Inventor: Saeid Reza Kashtiara, Tehran (IR)

(21) Appl. No.: 15/373,380

(22) Filed: Dec. 8, 2016

(51) Int. Cl. C02F 9/00; C22B 7/00; B03C 1/025; B01J 20/02; B01J 20/08

(52) U.S. Cl. CPC C02F 9/00; C22B 7/006; B03C 1/025; B01J 20/0229; B01J 20/0222; C02F 1/488; B01J 20/0211; B01J 20/0207; C02F 2303/04; C02F 2303/18; B01J 20/08

(57) ABSTRACT

A system and method for reducing pollutants in garbage leachate is disclosed. The system comprises multiple modules such as a screening module, a pH adjustment and mixing module, a separator module and a disinfection module operationally connected to each other. The screening module is configured to filter the leachate and the pH adjustment and mixing module is configured to adjust the pH of the filtered leachate to a predefined value. The leachate is mixed with a chemical or metal oxide composition, and the pollutants in the leachate are adsorbed by the chemical composition to provide a purified leachate. The separator module is configured to separate the adsorbed pollutant from the purified leachate. The disinfection module is configured to filter and disinfect the purified leachate to produce purified water. The method implemented using this system for reducing pollutants in a leachate is efficient and economical.

### BACKGROUND OF THE INVENTION

The development of a system and method for cleaning or purifying water from the garbage leachate is one of the major environmental issue. Several methods have been developed to eliminate or reduce pollutants in the water resources. Many studies have been conducted for using iron oxide (Fe₃O₄) nanoparticles for reducing pollutants in the garbage leachate. Further, it was also concluded that the heavy metals are adsorbed by its magnetism property, when it is distributed in an aqueous environment.

Some of the proposed prior arts attempted to purify the aqueous environment using iron particles are, James et. al., U.S. Pub. No. 2007/0119785 describes about purification systems and methods based on metal-mediated aeration. A wastewater treatment method includes the steps of providing a Fe source and contacting influent water including one contaminant in the presence of oxygen comprising gas flow to form a metal sludge.

Manuel et. al., U.S. Pub. No. 2015/0368122 discloses a method for manufacturing a support for a liquid treatment filter. Liquid treatment filter comprising a support made of a polymeric material having at least one functional group and thiol loaded with SPION (Superparamagnetic iron oxide nanoparticles). Singhvi, U.S. Pat. No. 5,238,580 relates to a method for treating leachate from a sanitary landfill in order to remove contaminating constituents.

The above said prior art are implemented with basic purification process such as, reverse osmosis, ion exchange, chemical method, biological method, and surface absorption. The implementation of these existing system and method is complex and expensive. The existing system and method produces large amount of waste material and sludge, and incurs high operational and maintenance cost. For example, reverse osmosis and ion exchange methods leads to the production of sludge and salt water after purification. Further, the existing art fails to deal with the attraction and separation of pollutants from the iron oxide nanoparticle with a synchronous process implemented in a unified system.

Therefore, there is a need in an art for a system and method for reducing pollutants in garbage leachate using a chemical or metal oxide nanoparticle composition. There is also a need for a system with economical design and efficient construction consuming less operation time for a garbage leachate treatment.

### SUMMARY OF THE INVENTION

The present invention relates to a system and method for reducing pollutants in garbage leachate. In an embodiment, the system comprises one or more modules such as a screening module, a pH adjustment and mixing module, a separator module and a disinfection module. In one embodiment, the modules are connected each other via pipes, reservoirs, and pumps. In another embodiment, the modules are connected each other via pipes, reservoir, PLC controller and pumps.

In an embodiment, the screening module is configured to filter the garbage leachate using a filter. In one embodiment, the garbage leachate is introduced by gravity through the iron oxide and silica filter. In one embodiment, the iron oxide and silica filter comprises a mesh of 60-70 microns. In an embodiment, the pH adjustment and mixing module is configured to determine and adjust the pH of the filtered leachate to a predefined value by adding water. In one embodiment, the leachate of predefined pH value is mixed with a chemical or metal oxide nano composition comprising, a mixture of iron oxide nanoparticles, aluminum oxide nanoparticles, titanium oxide nanoparticles and titanium oxide nanoparticles by ultrasonic waves for a predetermined time. In one embodiment, the pollutants in the leachate are adsorbed by the said chemical composition to provide a purified leachate.

In an embodiment, the separator module is configured to allow the purified leachate and the pollutant adsorbed metal oxide composition via a magnetic field to separate the pollutant adsorbed metal oxide composition from the purified leachate. In one embodiment, the magnetic field with a predetermined Gauss value is used to separate the pollutant adsorbed metal oxide composition from the purified leachate. The Gauss value could be between 5 G to 20000 G. In an embodiment, the disinfection module is configured to filter and disinfect the purified leachate to produce a pure water.

In an embodiment, the system further comprises one or more locking mechanisms in the modules to treat the garbage leachate for predetermined time. In one embodiment, the system further comprises pressure pumps in each module to treat the garbage leachate for predetermined time. In an embodiment, the pollutants filtered by the filter are collected by a pneumatic vacuum device.

In an embodiment, a chemical composition used for reducing pollutants in garbage leachate comprises a metal oxide nanoparticle composition. In one embodiment, the chemical composition comprises, an iron oxide nanoparticles ranges from 60% to 70% by weight, a titanium oxide nanoparticles ranges from 20% to 30% by weight, a magnesium oxide nanoparticles ranges from 1% to 10% by weight, and an aluminum oxide nanoparticles ranges from 1% to 10% by weight. In another embodiment, the chemical composition comprises, an iron oxide nanoparticles ranges from 68% by weight, a titanium oxide nanoparticles ranges from 22% by weight, a magnesium oxide nanoparticles ranges from 5% by weight, and an aluminum oxide nanoparticles ranges from 5% by weight.

The present invention also relates to a method for reducing pollutants in the garbage leachate. In an embodiment, the method includes filtering the garbage leachate using a filter in a first module. In a step of the method, the pH value of the filtered leachate is determined and adjusted by adding water in the second module. In another step of the method, the leachate of predefined pH value is mixed with a chemical or metal oxide composition comprising, a mixture of iron oxide nanoparticles, aluminum oxide nanoparticles, titanium oxide nanoparticles and titanium oxide nanoparticles in the second module. In another step, the method includes one or more pollutants in the leachate are adsorbed by the said chemical or metal oxide composition to provide a purified leachate in the second module.

In another step, the pollutant absorbed iron oxide nanoparticles are separated from the purified leachate in a third module. In final step of the method, the purified leachate is further filtered and disinfected to produce a pure water in a fourth module. In an embodiment, the purified leachate is further filtered using an iron oxide filter and disinfected using ozone gas in the fourth module. In one embodiment, the iron oxide filter comprises a mesh of 60-70 microns.

In an embodiment, the first module is a screening module, the second module is a pH adjustment and mixing module, the third module is a separator module, and the fourth module is a disinfection module. In one embodiment, the garbage leachate is transferred from one module to other module via pipes, reservoir, PLC controller and pumps. In one embodiment, the pH of the filtered leachate is adjusted to a predefined value by adding water. In one embodiment, the leachate of predefined pH value is mixed with a chemical or metal oxide composition comprising, a, mixture of iron oxide nanoparticles, aluminum oxide nanoparticles, titanium oxide nanoparticles and titanium oxide nanoparticles by ultrasonic waves for a predetermined time in the second module.

In one embodiment, the leachate of predefined pH value is mixed with the said chemical or metal oxide composition by ultrasonic waves of 10 Hz for 15 minutes. In one embodiment, the third module is configured to allow the purified leachate and the pollutant adsorbed metal oxide composition via a magnetic field with a predetermined Gauss value to separate the pollutant adsorbed metal oxide composition from the purified leachate.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 illustrates a block diagram of a system for or reducing pollutants in garbage leachate according to an embodiment.

FIG. 2A-2B illustrates a flowchart of a method for reducing pollutants in garbage leachate according to an embodiment.

FIG. 3 illustrates a microscopic view of the iron nanoparticles in landfill leachate treatment.

FIG. 4 illustrates a reaction of the iron nanoparticle composition to the various ingredients in the leachate composition.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention generally relates to a system and method for reducing pollutants in garbage leachate using nanoparticle composition. In one aspect, the present disclosure is directed to a system for reducing pollutants in a leachate. The system comprises one or more modules connected each other via pipes, reservoirs, and pumps, wherein the modules comprising: (a) a screening module configured to filter the leachate by a filter; (b) a pH adjustment and mixing module configured to determine and adjust the pH of the filtered leachate to a predefined value, wherein the leachate of predefined pH value is mixed with a chemical composition comprising, a mixture of iron oxide nanoparticles, aluminum oxide nanoparticles, titanium oxide nanoparticles and titanium oxide nanoparticles, by ultrasonic waves for a predetermined time, and wherein the pollutants in the leachate are adsorbed by the said composition to provide a purified leachate; (c) a separator module configured to allow the purified leachate and the pollutant adsorbed composition via a magnetic field with a predetermined Gauss value ranges from 5 G to 20000 G to separate the pollutant adsorbed composition from the purified leachate; and (d) a disinfection module configured to filter and disinfect the purified leachate to produce a pure water.

In one embodiment, the leachate is introduced by gravity through the iron oxide and silica filter mesh of 60-70 microns. In another embodiment, the system further comprises one or more locking mechanism in each module to treat the leachate for predetermined time. In one embodiment, the system further comprises pressure pumps in each module to treat the leachate for predetermined time. In one embodiment, the modules are connected each other via pipes, reservoir, PLC controller and pumps. In another embodiment, the disinfection module is configured to disinfect the filtered water by an ozone gas to produce a pure water. In one embodiment, the pollutants filtered by the filter are collected by a pneumatic vacuum device

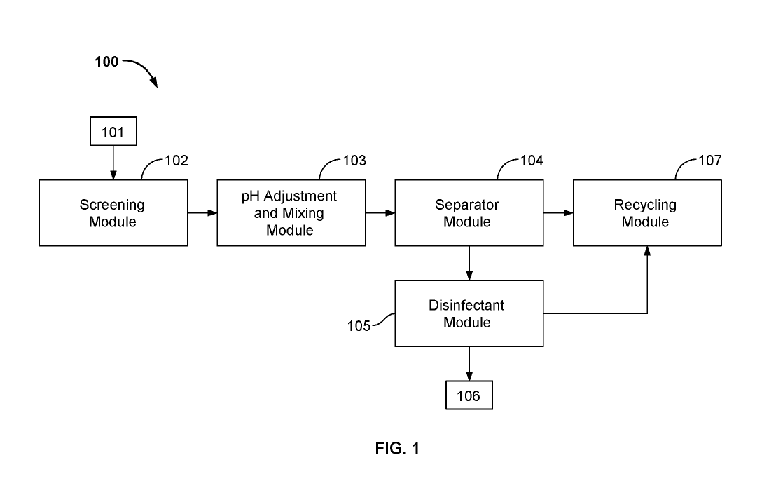

The present invention relates to a system and method for reducing pollutants in garbage leachate. Referring to FIG. 1, the system 100 comprises multiple modules or reservoirs such as a screening module, a pH adjustment and mixing module, a separator module and a disinfection module. In one embodiment, the modules or reservoirs are connected each other via pipes, reservoirs, and pumps. In another embodiment, the modules are connected each other via pipes, reservoir, PLC controller and pumps.

In an embodiment, the garbage leachate as an input 101 is introduced by gravity through the screening module 102. In an embodiment, the screening module 102 is configured to filter the garbage leachate using an iron oxide and silica filter. In one embodiment, the iron oxide and silica filter comprises a mesh of 60-70 microns. In one embodiment, the output-filtered leachate from the screening module 102 is passed to the pH adjustment and mixing module 103 via connecting elements such as pipes or pumps.

In an embodiment, the pH adjustment and mixing module 103 is configured to determine and adjust the pH of the filtered leachate to a predefined value by adding water. In one embodiment, the leachate of predefined pH value is mixed with a chemical or metal oxide composition comprising, a mixture of iron oxide nanoparticles, aluminum oxide nanoparticles, titanium oxide nanoparticles and titanium oxide nanoparticles by ultrasonic waves for a predetermined time in the pH adjustment and mixing module 103. In one embodiment, the pollutants in the leachate are adsorbed by the chemical or metal oxide composition to provide a purified leachate. In one embodiment, the output-purified leachate from the pH adjustment and mixing module 103 is passed to the separator module 104 via connecting elements such as pipes or pumps.

In an embodiment, the separator module 104 is configured to allow the purified leachate and the pollutant adsorbed metal oxide composition via a magnetic field to separate the pollutant adsorbed metal oxide composition from the purified leachate. In one embodiment, the magnetic field with a predetermined Gauss value is used to separate the pollutant adsorbed metal oxide composition from the purified leachate. The Gauss value could be between 5 G to 20000 G. In one embodiment, the separated pollutants are passed onto the recycling module 107 for further process of recycling the pollutant adsorbed metal oxide composition to next cycle. In one embodiment, the output-separated leachate from the separator module 104 is passed to the disinfection module 105 via connecting elements such as pipes or pumps.

In an embodiment, a disinfection module 105 is configured to filter and disinfect the purified leachate to produce a pure water. In another embodiment, the magnetic field with predetermined Gauss value helps in filtering of the metal oxide nanoparticle composition in the water. The Gauss value could be between 5 G to 20000 G. In one embodiment, the pure water is collected from the disinfection module 105 in the output reservoir 106 of the system 100. In another embodiment, the purified leachate is disinfected by passing ozone gas in the disinfection module 105. In one embodiment, the filtered pollutants and metal oxide nanoparticle composition are passed onto the recycling module 107 for recycling. In another embodiment, the recycling module 107 of the system 100 helps in restoring power generated by the gas obtained from the pollutants of the leachate.

In an embodiment, the system 100 further comprises multiple locking mechanisms in the modules to treat the garbage leachate for predetermined time. The locking mechanism provides an efficient adsorption of pollutant by the metal oxide nanoparticle composition. In one embodiment, the system 100 further comprises pressure pumps in each module to treat the garbage leachate for predetermined time. In another embodiment, treatment of garbage leachate under pressure pumps removes pollutants such as nitrates from the filters in the system. In an embodiment, the pollutants from the filters are collected by a pneumatic vacuum device.

In an embodiment, a chemical composition used for reducing pollutants in garbage leachate comprises a metal oxide nanoparticle composition. In one embodiment, the chemical composition comprises, an iron oxide nanoparticles ranges from 60% to 70% by weight, a titanium oxide nanoparticles ranges from 20% to 30% by weight, a magnesium oxide nanoparticles ranges from 1% to 10% by weight, and an aluminum oxide nanoparticles ranges from 1% to 10% by weight. In another embodiment, the chemical composition comprises, an iron oxide nanoparticles ranges from 68% by weight, a titanium oxide nanoparticles ranges from 22% by weight, a magnesium oxide nanoparticles ranges from 5% by weight, and an aluminum oxide nanoparticles ranges from 5% by weight.

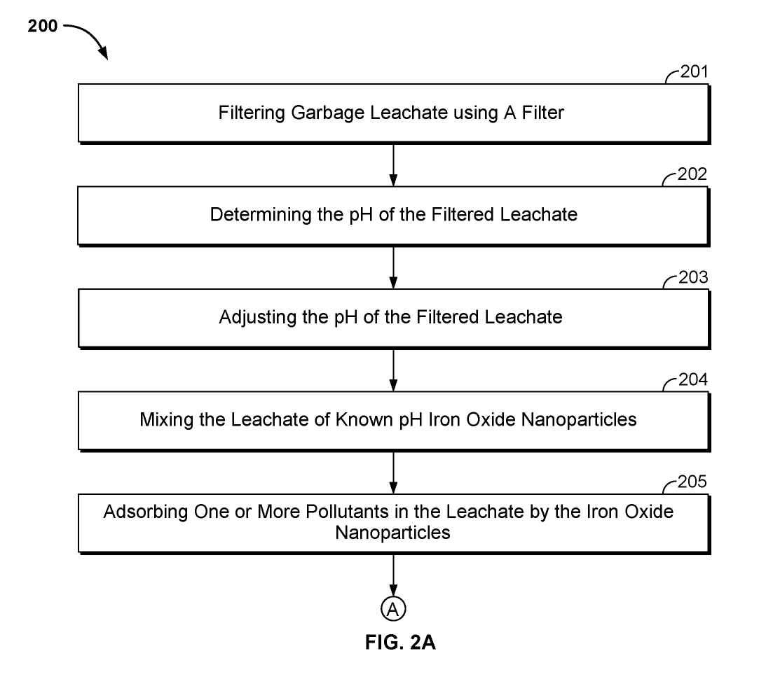

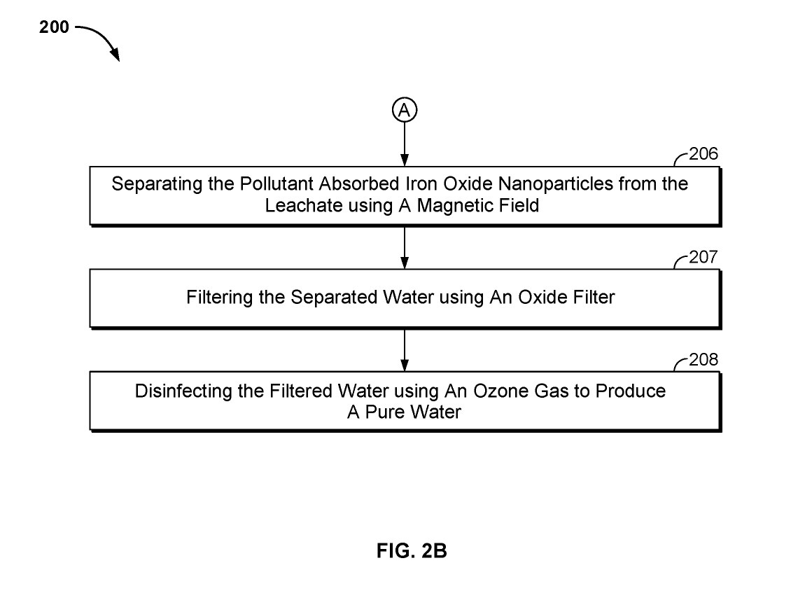

Referring to FIG. 2, a method 200 for reducing pollutants in the garbage leachate from step 201 to 208. In step 201, the method 200 includes filtering the garbage leachate using a filter in a first module. In step 202, the pH value of the filtered leachate is determined, and the pH value of the filtered leachate is adjusted in the second module in step 203. In one embodiment, the pH of the filtered leachate is adjusted to a predefined value by adding water.

In step 204, the leachate of predefined pH value is mixed with a chemical or metal oxide nanoparticle composition comprising, a mixture of iron oxide nanoparticles, aluminum oxide nanoparticles, titanium oxide nanoparticles and titanium oxide nanoparticles in the second module. In one embodiment, the leachate of predefined pH value is mixed with the said chemical composition by ultrasonic waves for a predetermined time in the second module. In one embodiment, the leachate of predefined pH value is mixed with the said chemical composition by ultrasonic waves for 15 minutes. In another embodiment, the ultrasonic waves generates the wave pre-defined with the said chemical composition. For example, 10 Hz.

In step 205, the method include pollutants in the leachate are adsorbed by the metal oxide nanoparticle composition to provide a purified leachate in the second module. In step 206, the pollutant absorbed metal oxide nanoparticle composition are separated from the purified leachate in a third module. In one embodiment, the third module is configured to allow the purified leachate and the pollutant adsorbed metal oxide nanoparticle composition via a magnetic field with a predetermined Gauss value to separate the pollutant adsorbed metal oxide nanoparticle composition from the purified leachate. The Gauss value could be between 5 G to 20000 G. In one embodiment, the separated pollutant adsorbed metal oxide nanoparticle composition is passed on to the recycling plant.

In step 207 of the method, the purified leachate is further filtered using a filter, and disinfected to produce a pure water in a fourth module in step 208. In an embodiment, the purified leachate is further filtered using an iron oxide filter, and disinfected using ozone gas in the fourth module. In one embodiment, the iron oxide filter comprises a mesh of 60-70 microns.

In an embodiment, the first module is a screening module, the second module is a pH adjustment and mixing module, the third module is a separator module, and the fourth module is a disinfection module. In one embodiment, the garbage leachate is transferred from one module to other module via pipes, reservoir, PLC controller and pumps. In one embodiment, the pollutants are heavy metals, organic compounds, waste materials, or any toxic chemicals.

In one embodiment, the production rate of the system is 200 liters per second based on the installed capacity. The system could be implemented in landfill and reservoirs, where the construction materials are selected based on the environmental investigation such as temperature, humidity, and other environmental conditions. The system reduces the water pollution in the environment with low operational cost and time. The proposed method is efficient and economical, where the system is constructed using inexpensive and readily available eco-friendly raw materials such as iron oxide, etc. The system is also capable of providing low amount of sludge, and helps in restoring power generated by the gas obtained from the leachate.

The invention is further explained in the following examples, which however, are not to be construed to limit the scope of the invention.

### EXAMPLES

### Example—1

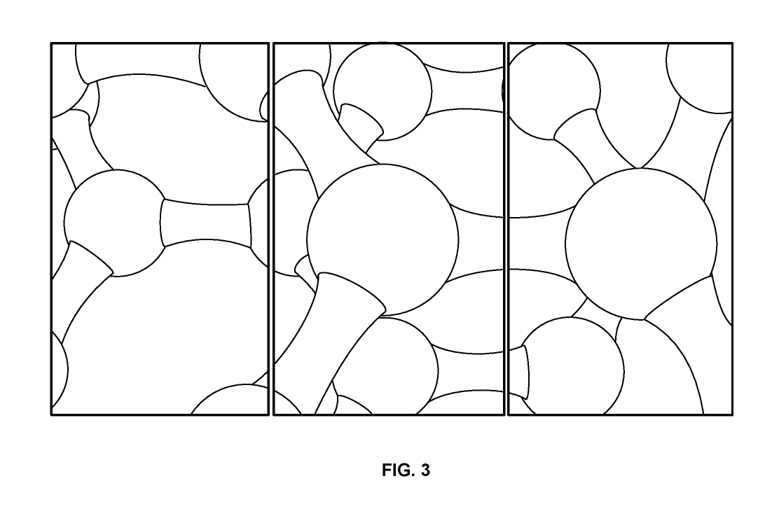

Due to the water crisis, the use of treated wastewater is an indirect source for household, industry and agriculture consumption. It is also required to prevent environmental pollution for water resources and aquatic life. One of the great sources of urban wastewater is water with high levels of organic compounds with chemical oxygen demand (COD), biochemical oxygen demand (BOD), nitrates and phosphates, which is difficult for optimal usage. In an experiment, the removal of these compounds from secondary wastewater using iron oxide nanoparticles (Fe₃O₄) absorbent are examined. FIG. 3 illustrates a microscopic view of the iron nanoparticles in landfill leachate treatment. The efficiency of Fe₃O₄ nanoparticles in the removal of organic compounds, nitrates, phosphates was conducted in a closed system. The effect of pH, time and adsorbent concentration by a time factor were examined.

The optimum conditions were determined based on a kind of a filter adsorption. The experiment is conducted on optimal conditions of 3 pH value with optimum exposure time of 11 mins and dosage of 11 g for absorbing nanoparticles of iron oxide. In optimal conditions, the removal of phosphate, nitrate, BOD, and COD are 54%, 11.5%, 56%and 75% capacity respectively. The absorption for COD, phosphate, BOD, and nitrogen by Freundlich and other models are 1.8 mg/g, 1.6 mg/g, 14 mg/g, and 25 mg/g, respectively.

### Example—2

The magnetite has good potential for phosphorus removal, BOD and COD of wastewater, which as a method for removing pollutants from sewage urban performance is:

| S. No. | Pollutant characteristics | Before treatment | After treatment |
|---|---|---|---|
| 1 | COD | 30800 | 22.5 |
| 2 | BOD | 15900 | 15 |
| 3 | Colour | 7408 | 16 |

Exposure to potential risks to human heavy metals, and because near the landfill, leachate treatment plant is necessary to groundwater resources and ecosystems. The most common method used to remove heavy metals absorbed. Among the adsorbents available, NMOS or the metal oxide (nano) composition are adsorbed by the metal oxide nanoparticle composition. Among the adsorbents available, NMOS or the metal oxide (nano) composition was nano-sized as heavy metals adsorbents, which contains iron oxide, manganese oxide, aluminum oxide, titanium oxide and cerium oxide has high specific surface and a strong tendency to absorb heavy metals in an aqueous solution. Meanwhile, NMOS of magnetic nanoparticles of iron oxide from the position great and they are very important, because in a magnetic field to easily separate from the solution, and this case to recover, reuse and reduce the costs very effective.

### Example—3

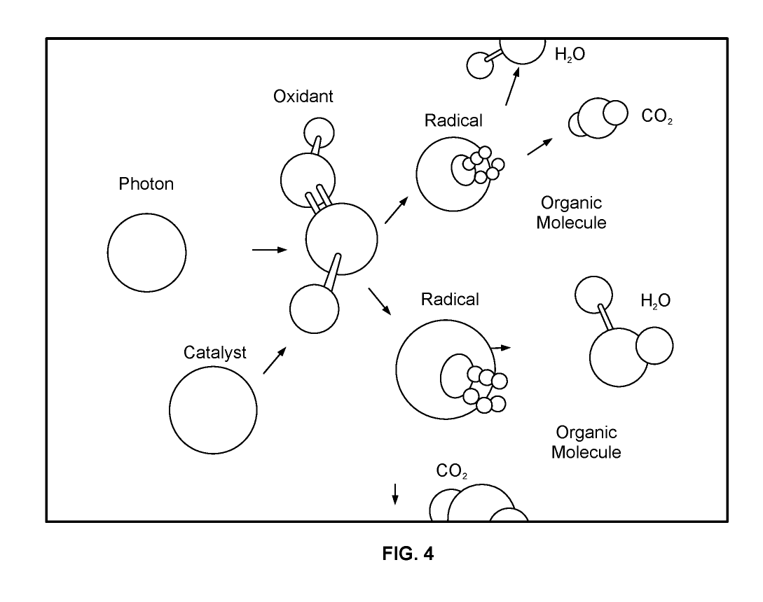

FIG. 4 illustrates a reaction of the iron nanoparticle composition to the various ingredients in the leachate composition. The composition of the leachate consists of varying amount of heavy metals; however, metals such as lead, zinc and manganese in the leachate are dominant. The removal of heavy metals, lead, zinc and manganese oxide nanoparticles in aqueous solutions or in leachate by iron oxide (Fe₃O₄), and optimize this process were investigated. Iron oxide nanoparticles were synthesized by various known methods. Among these methods, co-precipitation method was opted, because the process was relatively simple with appropriate lab facilities. Sol-gel process could also be used for the stable production of magnetite nanoparticles coated with silica gel was used.

Parameters such as pH, reaction time, amount of adsorbent dosage and amount of metal contaminants in the solution are determined, and maintained effective in the removal of heavy metals from aqueous solution. The results showed that with increasing pH, heavy metals removal efficiency increases. Further, the heavy metals were removed in 20 min; removal efficiency reached its maximum value by increasing the reaction time. Beyond 20 min, removal efficiency does not find a significant effect.

Response surface methodology was used to optimize these parameters in aqueous solution to remove heavy metals. The results showed that the optimal conditions of iron oxide nanoparticles are able to remove more than 92% lead, 99% manganese, and 100% heavy metals in the aqueous solution. The absorption capacity of 97.8 mg/g magnetite nanoparticles was capable of removing zinc from the aqueous solution.

### Example—4

In an experiment, 5 gms of iron oxide nanoparticles in every one liter of leachate waste are applied or introduced for treatment, as specified in the Table. 1. The treatment could be carried out for 15 minutes at 25° C. From the first test, it could be observed that 95% of the heavy metals were eliminated, whereas it could remove 75% of the tiff, color, nitrate, and phosphate.

TABLE 1
Results for treating garbage leachate waste using iron oxide nanoparticles
In second experiment, in addition to the initial iron oxide nanoparticles,
titanium oxide nanoparticles magnesium oxide nanoparticles, and
aluminum oxide nanoparticles in a predetermined composition, are
introduced to improve the efficiency of removing/eliminating waste
leachate. These four nanoparticles of the composition were initially
introduced into a homogenizer for uniformity, and then heated to 250° C.

| S. No. | Pollutants characteristics | Before Treatment | After Treatment |
|---|---|---|---|
| 1 | Nitrate | 450 m/g | 112.50 m/g |
| 2 | BOD5 | 15900 m/g | 150 m/g |
| 3 | COD | 30800 m/g | 150 m/g |
| 4 | Color | 7408 PTCO | 110 PTCO |
| 5 | Tiff | 58.7 NTU | 18.3 NTU |
| 6 | Phosphate | 360 m/g | 98.50 m/g |
| 7 | Copper | 0.108 m/g | 0.0011 m/g |
| 8 | Manganese | 9 m/g | 0..63 m/g |
| 9 | Lead | 0.28 m/g | <0.01 m/g |
| 10 | Iron | 6.21 m/g | 0.08 m/g |
| 11 | Chromium | 0.276 m/g | 0.02 m/g |
| 12 | Titanium | 0.23 m/g | <0.02 m/g |
| 13 | platinum | <0.5 m/g | <0.05 m/g |

### Example—5

The method of reducing pollutants in the garbage leachate using this combination of nanoparticles in the composition eliminates 95% of all the pollutants. Table 2 displays a suitable composition for treating leachate waste.

TABLE 2
Composition for treating garbage leachate waste in second
test

| S. No. | Composition | Weight % |
|---|---|---|
| 1 | Iron oxide nanoparticles | 68% |
| 2 | Titanium oxide nanoparticles | 22% |
| 3 | Magnesium oxide | 5% |
| | nanoparticles | |
| 4 | Aluminium oxide | 5% |
| | nanoparticles | |

In general, none of the above-mentioned metals in the composition such as titanium oxide, magnesium oxide, iron oxide, aluminum oxide, is found in the nature. They exit in iron compounds, and separated using different techniques in the known arts. Therefore, iron oxide has a strong tendency to absorb the other three types of nanoparticles, which consequently gains magnetic properties from iron oxide.

### Example—5

Further, when the combination of the nanoparticles in the composition with the leachate waste is exposed to ultrasonic waves for 5 minutes, all the pollutants are eliminated, and separated from the leachate waste.

In the second test, each liter of garbage juice is treated with 5 grams of the combination of the above mentioned nanoparticles of the composition with proportions displayed in Table 2 were heated to 25° C. The results of the second test is shown in Table 3.

TABLE 3
Results for treating garbage leachate
waste using the formulated composition

| S. No. | Pollutants characteristics | Before treatment | After Treatment |
|---|---|---|---|
| 1 | Nitrate | 450 m/g | 6.2 m/g |
| 2 | BOD5 | 15900 m/g | 15 m/g |
| 3 | COD | 30800 m/g | 22.5 m/g |
| 4 | Color | 7408 PTCO | 16 PTCO |
| 5 | Tiff | 58 NTU | 2.1 NTU |
| 6 | Phosphate | 360 m/g | 4.2 m/g |
| 7 | Copper | 0.108 m/g | 0.0044 m/g |
| 8 | Manganese | 9 m/g | 0..63 m/g |
| 9 | Lead | 0.28 m/g | <0.01 m/g |
| 10 | Iron | 6.21 m/g | 0.08 m/g |
| 11 | Chromium | 0.276 m/g | 0.02 m/g |
| 12 | Titanium | 0.23 m/g | <0.02 m/g |
| 13 | platinum | <0.5 m/g | <0.05 m/g |

Based on these tests, titanium oxide nanoparticle in the composition is found to remove the tiff and color of garbage juice. The titanium oxide nanoparticle also helps in eliminating or removing nitrate and phosphate from the leachate waste. Both, magnesium oxide and iron oxide nanoparticles helps in eradicating heavy metals. The aluminum oxide nanoparticles helps to remove soluble suspended solids in the leachate waste.

The combination of these four nanoparticles in the composition can be used as general formula to remove all the pollutants in the leachate waste. According to the tests, the proportion of the four nanoparticles in the composition could be altered based on an analysis of the garbage juice and its ingredients. However, the composition should not exceed 5 gms, since the quantity does not affect the reaction, and it is directly correlated with the time required to react/combine with the garbage juice.

The amount of titanium oxide nanoparticles could be increased, and equally by reducing iron oxide nanoparticles in the composition, if the garbage juice exceeds above 7000 PTCO. In another condition, if the heavy metals exceed above 9 m/g in the garbage juice, iron oxide nanoparticles in the composition could be increased, and by reducing aluminum oxide nanoparticles in the composition.

Similarly, if the nitrate and phosphate content exceeds 500 mg/l in the garbage juice, magnesium oxide nanoparticle proportion in the composition could be increased, by equally reducing iron oxide nanoparticle proportion in the composition.

The refining process using this composition requires or consumes less time, for example, less than 15 minutes. However, as the density of garbage juice increases and proportion of contents in the composition is altered, depending on the garbage juice analysis, where the process requires or consumes less time between 15 to 45 minutes.

Another aspect of the present disclosure is directed to a chemical composition used for reducing pollutants in a leachate, comprising: (a) an iron oxide nanoparticles ranges from 60% to 70% by weight; (b) a titanium oxide nanoparticles ranges from 20% to 30% by weight; (c) a magnesium oxide nanoparticles ranges from 1% to 10% by weight, and (d) an aluminum oxide nanoparticles ranges from 1% to 10% by weight. In a related embodiment, the composition further comprises an iron oxide nanoparticles ranges from 68% by weight; a titanium oxide nanoparticles ranges from 22% by weight; a magnesium oxide nanoparticles ranges from 5% by weight; and an aluminum oxide nanoparticles ranges from 5% by weight.

One aspect of the present disclosure is directed to a method for reducing pollutants in a leachate, comprising: (a) filtering the leachate by a filter in a first module; (b) determining and adjusting pH of the filtered leachate by adding water in a second module; (c) mixing the leachate of predefined pH value with a chemical composition comprising, a mixture of iron oxide nanoparticles, aluminum oxide nanoparticles, titanium oxide nanoparticles and titanium oxide nanoparticles, in the second module; (d) adsorbing one or more pollutants in the leachate by the said chemical composition to provide a purified leachate in the second module; (e) separating the pollutant absorbed chemical composition from the purified leachate in a third module; and (f) filtering and disinfecting the purified leachate to produce a pure water in a fourth module.

In one example, the first module is a screening module, the second module is a pH adjustment and mixing module, the third module is a separator module, and the fourth module is a disinfection module. In another example, the leachate is transferred from one module to other module via pipes, reservoir, PLC controller and pumps. In one embodiment, the leachate is introduced by gravity through the iron oxide and silica filter mesh of 60-70 microns. In one embodiment, the pH of the filtered leachate is adjusted to a predefined value by adding water. In another embodiment, the leachate of predefined pH value is mixed with the said chemical composition by ultrasonic waves of 10 Hz for a predetermined time. In one embodiment, the third module is configured to allow the purified leachate and the pollutant adsorbed chemical composition via a magnetic field with a predetermined Gauss value ranges from 5 G to 20000 G to separate the pollutant adsorbed chemical composition from the purified leachate. In another embodiment, the leachate of predefined pH value is mixed with the said chemical composition by ultrasonic waves for 15 minutes. In one embodiment, the method further comprises disinfecting the purified leachate by an ozone gas to produce a pure water. In a related embodiment, the pollutants filtered by the filter are collected by a pneumatic vacuum device.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A system for reducing pollutants in a leachate, comprising:
one or more modules connected each other via pipes, reservoirs, and pumps, wherein the modules comprising:
a screening module configured to filter the leachate by a filter;
a pH adjustment and mixing module configured to determine and adjust the pH of the filtered leachate to a predefined value, wherein the leachate of predefined pH value is mixed with a chemical composition comprising, a mixture of iron oxide nanoparticles, aluminum oxide nanoparticles, titanium oxide nanoparticles and titanium oxide nanoparticles, by ultrasonic waves for a predetermined time, and wherein the pollutants in the leachate are adsorbed by the said composition to provide a purified leachate;
a separator module configured to allow the purified leachate and the pollutant adsorbed composition via a magnetic field with a predetermined Gauss value ranges from 5 G to 20000 G to separate the pollutant adsorbed composition from the purified leachate; and
a disinfection module configured to filter and disinfect the purified leachate to produce a pure water

2. The system of claim 1, wherein the leachate is introduced by gravity through the iron oxide and silica filter mesh of 60-70 microns.

3. The system of claim 1, further comprising one or more locking mechanism in each module to treat the leachate for predetermined time.

4. The system of claim 1, further comprising pressure pumps in each module to treat the leachate for predetermined time.

5. The system of claim 1, wherein the modules are connected each other via pipes, reservoir, PLC controller and pumps.

6. The system of claim 1, wherein the disinfection module is configured to disinfect the filtered water by an ozone gas to produce a pure water.

7. The system of claim 1, wherein the pollutants filtered by the filter are collected by a pneumatic vacuum device.

8. A chemical composition used for reducing pollutants in a leachate, comprising:
an iron oxide nanoparticles ranges from 60% to 70% by weight;
a titanium oxide nanoparticles ranges from 20% to 30% by weight;
a magnesium oxide nanoparticles ranges from 1% to 10% by weight, and
an aluminum oxide nanoparticles ranges from 1% to 10% by weight.

9. The chemical composition of claim 8, further comprising:
an iron oxide nanoparticles ranges from 68% by weight;
a titanium oxide nanoparticles ranges from 22% by weight;
a magnesium oxide nanoparticles ranges from 5% by weight, and
an aluminum oxide nanoparticles ranges from 5% by weight.

10. A method for reducing pollutants in a leachate, comprising:
filtering the leachate by a filter in a first module;
determining and adjusting pH of the filtered leachate by adding water in a second module;
mixing the leachate of predefined pH value with a chemical composition comprising, a mixture of iron oxide nanoparticles, aluminum oxide nanoparticles, titanium oxide nanoparticles and titanium oxide nanoparticles, in the second module;
adsorbing one or more pollutants in the leachate by the said chemical composition to provide a purified leachate in the second module;
separating the pollutant absorbed chemical composition from the purified leachate in a third module, and
filtering and disinfecting the purified leachate to produce a pure water in a fourth module.

11. The method of claim 10, wherein the first module is a screening module, the second module is a pH adjustment and mixing module, the third module is a separator module, and the fourth module is a disinfection module.

12. The method of claim 10, wherein the leachate is transferred from one module to other module via pipes, reservoir, PLC controller and pumps.

13. The method of claim 10, wherein the leachate is introduced by gravity through the iron oxide and silica filter mesh of 60-70 microns.

14. The method of claim 10, wherein the pH of the filtered leachate is adjusted to a predefined value by adding water.

15. The method of claim 10, wherein the leachate of predefined pH value is mixed with the said chemical composition by ultrasonic waves of 10 Hz for a predetermined time.

16. The method of claim 10, wherein the third module is configured to allow the purified leachate and the pollutant adsorbed chemical composition via a magnetic field with a predetermined Gauss value ranges from 5 G to 20000 G to separate the pollutant adsorbed chemical composition from the purified leachate.

17. The method of claim 10, wherein the leachate of predefined pH value is mixed with the said chemical composition by ultrasonic waves for 15 minutes.

18. The method of claim 10, further comprising disinfecting the purified leachate by an ozone gas to produce a pure water.

19. The method of claim 10, wherein the pollutants filtered by the filter are collected by a pneumatic vacuum device.
